(19) United States
(12) Patent Application Publication
(10) Pub. No.: US 2008/0276203 A1
(43) Pub. Date: Nov. 6, 2008

(54) USER INTERFACE AND COOKING OVEN PROVIDED WITH SUCH USER INTERFACE

(75) Inventors: MATTEO SANTINATO, ALBIGNASEGO (IT); ETTORE ARIONE, LEGGIUNO (IT)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/114,868

(22) Filed: May 5, 2008

(30) Foreign Application Priority Data
May 4, 2007 (EP) 07107480.1

(51) Int. Cl. G06F 3/00

(52) U.S. Cl. 715/863

(57) ABSTRACT

An user interface for domestic appliances, particularly for cooking ovens, comprises input and display for showing menus and/or items selected by the user through said input. The input comprises a selection zone where the user's finger can move, the display having at least a portion with a shape substantially corresponding to the shape of the selection zone and showing the result of the finger movement in terms of item or menu selection.

### BACKGROUND OF THE INVENTION

1. Field of the Invention

The present invention relates to a user interface for domestic appliances, particularly for cooking ovens, comprising input and display for showing menus and items selected by the user through the input.

2. Description of the Related Art

It is well known in the art of domestic appliances to use electronic user interfaces with buttons or with a touch control panel in order to set functions and/or parameters according to the user's choice. There exist many styles of input devices for consumer products; in domestic appliances are mainly used knobs and switches, buttons and touch screens. Each technology has advantage and disadvantages that are taken in consideration in designing a new appliance. By pressing a button or by touching a zone of the touch control panel the user can set his choices.

The use of a touch sensitive display in domestic appliances, particularly in cooking appliances, presents the disadvantage of easily soiling the display if this latter is touched with not perfectly clean fingers. This can cause problems in reading correctly the various parameters and/or functions to be chosen by the user. In view of the several choices of parameters/functions of a modern appliance, it is often necessary to use big displays that have a negative impact on the overall cost of the appliance.

### SUMMARY OF THE INVENTION

One aspect of the present invention is to provide a user interface which does not have the above mentioned problems and which is economical to produce and install on a domestic appliance.

This aspect is achieved thanks to the features listed in the appended claims.

Another aspect of a user interface according to the present invention relates to its improved cleanability. The user interface according to the present invention may work independently on the appliance door configuration (open or closed), self-updating sensitivity to compensate also the humidity and high temperature. The new user interface establishes a direct feedback from the action of the customer finger and the selected item on the menu displayed to improve usability.

One of main items of the present invention is to improve the cleanability by developing a new user interface that permits also full flat implementation thereof. The user interface according to the present invention improves also the usability thereof since the movement of input pointer, i.e. the user's finger, corresponds to the relative movements of the selector in the graphical user interface.

Just few touch buttons are required to activate the user selection or move back to a previous menu or simply to switch ON/OFF the entire appliance.

The graphical user interface is also designed to minimise the actions required by the user to select the common functionalities of the appliance. An improved version of the graphical user interface may also identify and store, in a special memory, the most used selections to update properly the user interface menu with the user personal preferences.

### BRIEF DESCRIPTION OF THE DRAWINGS

Further advantages and features according to the present invention will become clear from the following detailed description provided by way of non-limiting example, with reference to the appended drawings in which:

FIG. 1 is a block diagram of user interface unit according to a first embodiment of the present invention;

FIGS. 2-4 are block diagrams of user interfaces according to different embodiments of the present invention;

FIG. 5 is an example of how the invention is implemented on a domestic appliance;

FIG. 6 is another example of implementation similar to the one of FIG. 5,

FIG. 7 is a detailed example of circle user interface navigation for a domestic oven according to the embodiment of FIG. 1 of the present invention; and

FIG. 8 is a schematic frontal view of a domestic oven having the user interface according to the present invention in two different configurations of the oven.

### DETAILED DESCRIPTION OF THE PREFERRED EMBODIMENTS

With reference to FIG. 1 a user interface 10 for an appliance comprises a touch input annular zone A1 where the user moves its finger to interact with the appliance. With B1 it is indicated the electronic device that reads the input sensors and “translates” it into a relative similar movement in the output display device C1, in this first embodiment following a circle path and selecting the closer item in the menu displayed. A processor is provided which is able to collect input from sensitive area A1 and to organise the menu properly in the display area C1 in order to obtain an intuitive navigation with a direct feedback of finger moving in the sensitive input zone A1. The user interface processor is connected with the appliance with an interface device, for example with a bi-directional bus.

The display C1 of the output device may be a LCD, colour LCD, OLED, VFD or any adequate similar device. In the case shown in FIG. 1 item 1 is shown as the one selected. In the case of a cooking appliance, the item can be the function of the oven (i.e. grill, fan, activated heating element etc.) or any parameters thereof (temperature, humidity, time etc.).

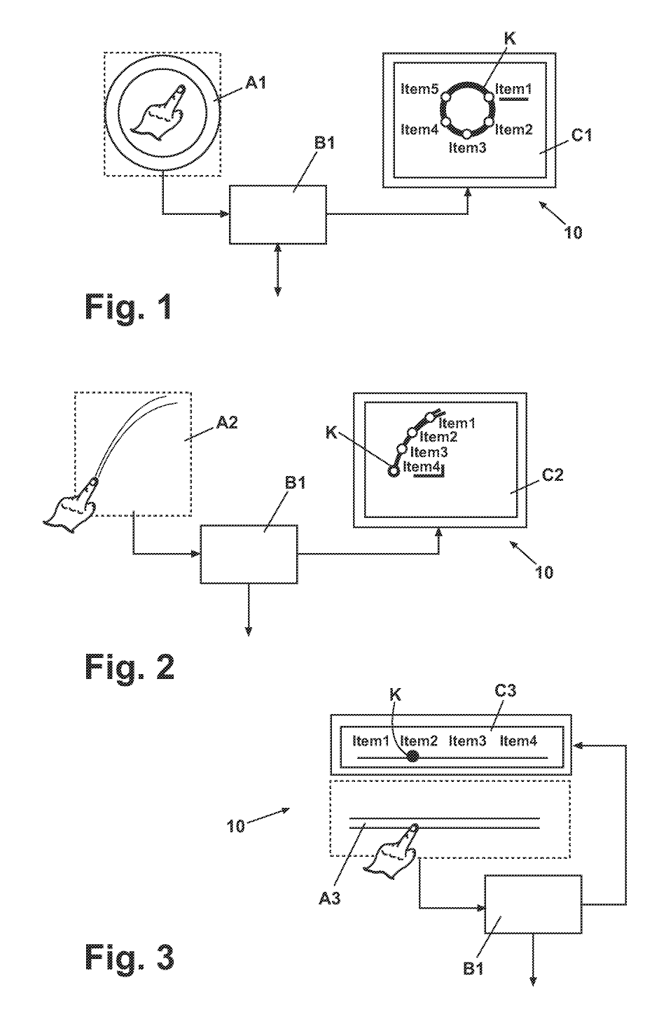

In FIG. 2 a second embodiment is shown in which a touch input zone A2 has a curved line shape, similar to the curved line path of the corresponding display zone C2. In this case item 4 is shown as the one selected.

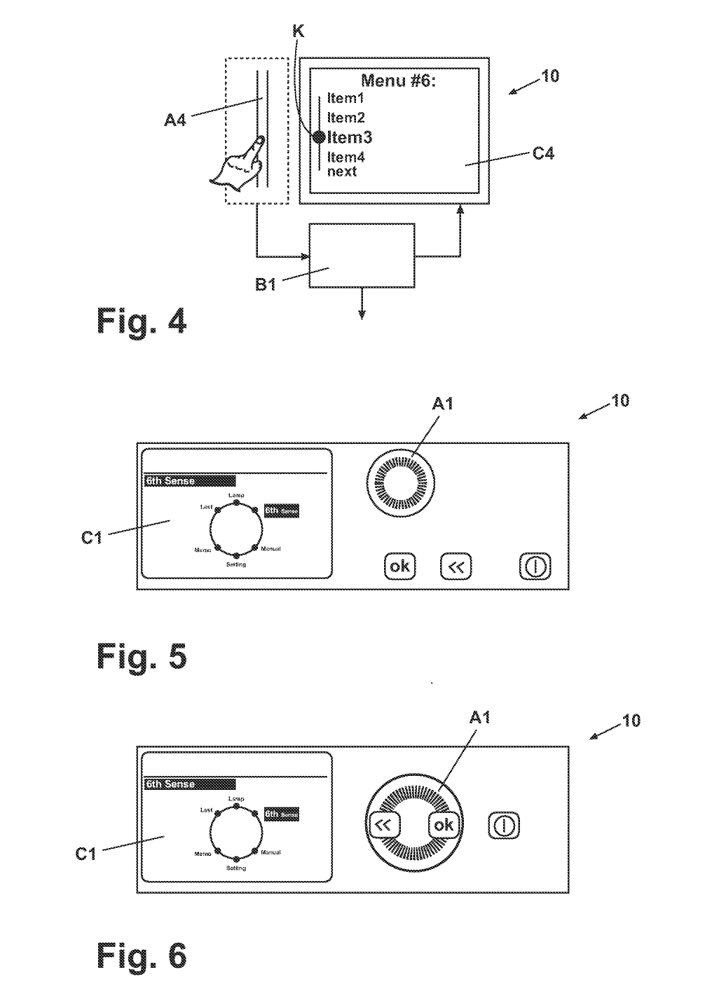

In FIG. 3 a third embodiment is shown in which a touch input zone A3 has an horizontal linear shape, corresponding to the horizontal linear shape of the display zone C3, while in FIG. 4 the touch input zone A4 and the corresponding display zone C4 have vertical linear shapes. In these shown embodiments item 2 for horizontal and item 3 for vertical version are selected. A small black circle K is used to give a direct feedback of user finger position.

FIG. 5 shows a real implementation of the first embodiment (circular version) of the invention. The large graphical display permits to reserve an area for the contest help and displays the parameters already selected from user.

In the pictures is also possible to identify one aim of the invention, the correspondence between the circle menu C1 and the area A1 sensitive to user's finger. A separate “OK” button confirms the selected option permitting to pass in the following menu and to select optional sub-options. Separate buttons to switch on/off the appliance and move to previous menu are included.

FIG. 6 shows another real implementation of the invention where some buttons are located inside the circle touch sensor A1 and a special more sophisticated software is necessary to assess when the user finger is selecting in the menu options or confirming the selected feature clicking OK zone. Perceptible vibrations may help the customer to understand that touched zone is selecting an active items in the menu.

The user interface according to the present invention is specifically useful for domestic built-in oven in which the user interface is placed on the oven door. Modem ovens have a wide door that may include also a space previously taken by the front panel of the oven. Therefore the old known interface with knobs and buttons are no longer suitable for slim glass door where a user interface must have a thickness which is comparable to the thickness of the glass door or in which the user interface is covered by a full glass door. The user interface according to the present invention is particularly suitable for the above kind of modern ovens due to its reduced thickness and absence of moving components.

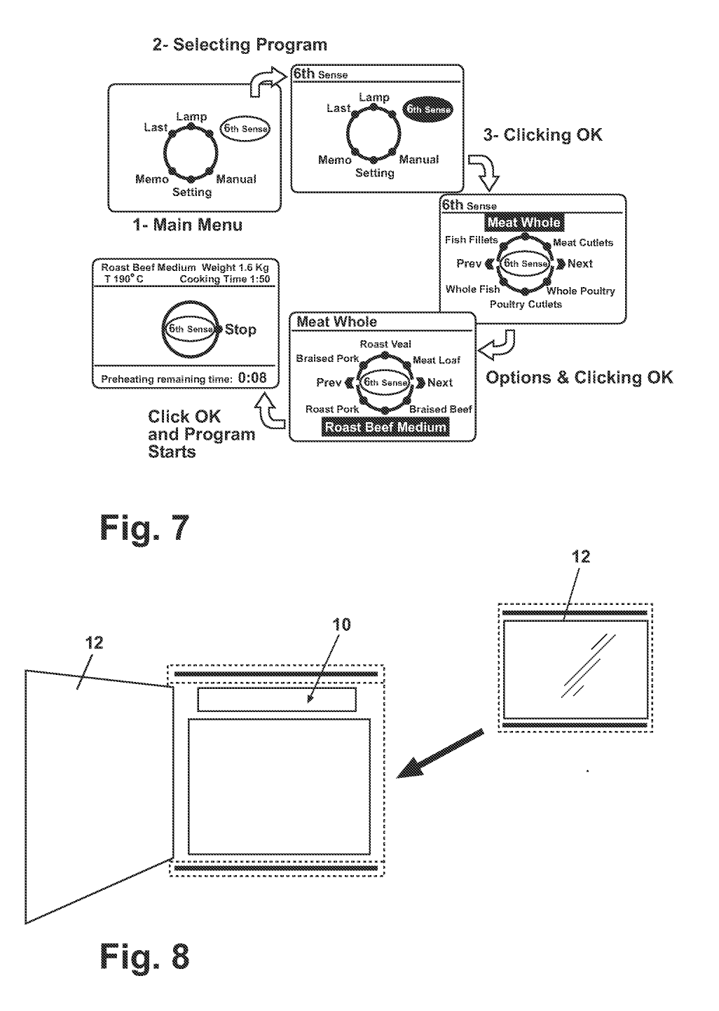

FIG. 7 shows a more detailed example of user interface navigation according to the general embodiment of FIG. 1. This figure shows how the present invention permits to activate the appliance by selecting a cooking program. In this specific example, the user is activating the option “6^{th} sense” and cooking roast beef in few steps, just moving the finger in the circular sensitive zone A1 (FIG. 1) and confirming the selections with the “OK” button (FIG. 5 or FIG. 6).

FIG. 8 shows how the user interface 10 according to the present invention may be used for a domestic oven either with the door open (left portion of FIG. 8) or closed (right portion of FIG. 8). In FIG. 8 with 12 it is indicated a full glass door which covers the whole user interface area comprising the touch screen area and the display device. By using the electronic control device associated to the user interface, the touch zone of the user interface 10 updates its sensitivity in order to interact properly with the user in the above two configurations (door open or door closed). Such update is triggered by a sensor or by a switch detecting the configuration of the door 12.

We claim:

1. A user interface for domestic appliances, comprising:
an input having a selection zone where the user's finger can move; and
a display for showing menus and/or items selected by the user through the input and having at least a portion with a shape substantially corresponding to the shape of the selection zone and showing the result of the finger movement in terms of item or menu selection.

2. The user interface according to claim 1, wherein the selection zone and the corresponding portion of the display have a shape selected in the group consisting of circular shape, linear shape, curved shape.

3. The user interface according to claim 1, wherein the input further includes auxiliary zones adapted to be touched by the user in order to confirm the item selection and/or to scroll among different menus or items.

4. The user interface of claim 1, wherein the interface is installed on the door of the appliance.

5. The user interface of claim 2, wherein the interface is installed on the door of the appliance.

6. The user interface of claim 3, wherein the interface is installed on the door of the appliance.

7. The interface of claim 1, wherein the appliance is a cooking oven having a cavity closed by a full glass door covering the user interface and the display wherein menus and/or items may be selected by the user through the full glass door.

8. The user interface of claim 7, wherein the user interface comprises a control device capable of sensing the configuration of the door and updating the sensitivity of the user interface according to the detected configuration of the door.
